(19) United States
(12) Patent Application Publication
(10) Pub. No.: US 2026/0229869 A1
(43) Pub. Date: Aug. 6, 2026

(54) LINE GUIDING DEVICE COMPRISING SINGLE-PART LONGITUDINAL PORTIONS, AND GUIDE PIECE THEREFOR

(71) Applicant: IGUS GMBH, Köln (DE)

(72) Inventor: Jörg DOMMNIK, Köln (DE)

(21) Appl. No.: 19/149,782

(22) PCT Filed: Jan. 19, 2024
(86) PCT No.: PCT/EP2024/051286

§ 371 Date: Jul. 21, 2025

(30) Foreign Application Priority Data
Jan. 24, 2023 (DE) 20 2023 100 342.7

(51) Int. Cl. H02G 11/00; F16G 13/16

(52) U.S. Cl. CPC H02G 11/006; F16G 13/16

(57) ABSTRACT

A cable routing device which is used to move supply lines between two connection points. At least one longitudinal section is manufactured integrally with a plurality of segments which can be pivoted towards each other in the longitudinal direction by a flexible connection. The segments each have a central region comprising: on a first side of a main plane, a first receiving space which is delimited by a first web transverse to the main plane, and by a first side part held by said web, and by a first main surface of the central region; and, on an opposite second side of the main plane, a second receiving space which is delimited by a second web transverse to the main plane, and by a second side part held by said web, and by a second main surface of the central region. Both webs, as well as the first and second side parts, are manufactured integrally with the central region. A flexible joint region can also be manufactured integrally with the central regions of two longitudinally consecutive segments in order to provide the flexible connection.

### FIELD

The invention relates generally to a device for the protected guidance of at least one line, for example a cable, a hose or the like, between two connection points, at least one of which is movable, typically between one fixed and one movable connection point.

### BACKGROUND

A line guide can typically receive a plurality of lines. A very widely used example is the so-called energy guiding chain. This consists of individual links, which are normally assembled from a plurality of individual parts. The applicant's patents DE3531066C2, EP0803032B1 and EP1381792B1 describe such energy guiding chains having links consisting of two, four or six individual parts. Such chains have proven very successful. They are robust and reliable but are complex to manufacture and assemble. Energy guiding chains are typically designed with articulated connections in the form of rotary joints or hinges between two connected links.

The generic subject of the present application is a line guiding device for movably guiding at least one supply line, wherein at least one longitudinal portion of the line guiding device comprises a plurality of segments and is manufactured as a single part, and wherein the segments are interconnected in a longitudinal direction by means of a flexible connection, such that the segments are pivotable relative to one another in a pivoting plane, in particular for the purposes of forming a deflecting bend during movement of the line guiding device. The segments define a receiving space in which at least one supply line can be placed in order to remain guided therein during operation.

Such line guiding devices, which do not technically constitute link chains and have no distinct rotary joints, are sometimes also referred to in the technical field as “band chains”.

“Band chains” manufactured partially or entirely as a single part, i.e. in one piece, are already known for example from U.S. Pat. No. 3,473,769 A, from EP 0 724 101 A1, from WO 00/11772 A1 or from DE 10 2007 038 747 A1. These line guiding devices are typically manufactured by extrusion and must subsequently undergo reworking, in particular cutting reworking, in order to produce individual segments. This is relatively laborious, and shape modifications, for example for the purposes of changing the radius or minimum pivot angle, are not readily possible.

By contrast, the geometry makes it more difficult for such, normally at least partially, one-piece line guiding devices to be manufactured by injection molding. One approach for this has been proposed in WO 98/40645 A1. Here, as a segment, a foldable protective element consisting of plastics material is manufactured in one piece, in an approximately planar, flat configuration, by injection molding. The segment has flexible bridges for the purposes of deforming an individual region of the segment by folding to form a link that defines a peripherally closed receiving space. This too requires extensive, typically manual, reworking in order to manufacture a ready-to-use line guiding device.

Another approach was proposed by the applicant in DE 198 60 948 A1. In said document, individual segments are manufactured in single-part or multi-part form by injection molding, similarly to conventional links, and are subsequently mounted onto a flexible sliding band.

### SUMMARY

It is therefore an object of the present invention to propose a design which allows single-part sections to be manufactured by plastics injection molding and in particular simplifies the manufacture of ready-to-use constituent parts of the line guiding device, that is to say of constituent parts that require no reworking.

Proposed is a line guiding device for movably guiding at least one supply line, for example an electrical or data cable, between two connection points, at least one of which is movable relative to the other, wherein at least one longitudinal portion of the line guiding device comprises a plurality of segments and is manufactured as in one piece. Here, the segments may be interconnected in a longitudinal direction by means of a flexible connection, such that the segments are pivotable relative to one another in a pivoting plane, in particular for the purposes of forming a deflecting bend during movement of the line guiding device. The segments typically define at least one receiving space in which at least one supply line can be placed in order to remain guided or held therein during operation.

Essentially, the invention proposes that the segments each have a central region having a main plane that extends perpendicular to the pivoting plane, and the segments are formed with a first receiving space on a first side of the main plane and with a second receiving space on an opposite, second side of the main plane. Simply by means of this design having receiving spaces on both sides, it is achieved that the central region can be manufactured as a region which, in the molding tool, is oriented parallel to the closing or demolding direction, or vertically. This yields a significant simplification, because the demolding operation can be significantly simplified, and manufacturing using simpler tools (so-called open/closed tools without slides) is made possible.

In particular, the first receiving space is delimited by a first connecting piece transverse to the main plane and by a first side part held on said connecting piece and by a first main surface of the central region. Analogously, the second receiving space is situated on the opposite, second side of the main plane and is delimited by a second connecting piece transverse to the main plane and by a second side part held on said connecting piece and by a second main surface of the central region. This geometry allows simplified manufacture, into a ready-to-use state, by the preferred process of injection molding, in which all of the main regions of a segment can easily be manufactured in one piece.

The invention proposes in particular that the first and the second connecting piece and the first and the second side part are each manufactured in one piece with the central region, and at the same time at least one flexible joint region is manufactured in one piece with the central regions of in each case two longitudinally successive segments in order to provide the flexible connection between said segments. Thus, all of the main structural regions of the longitudinal portion can be manufactured as a one piece plastics part.

By means of the proposed design, the side for the insertion and removal of lines, said side being situated opposite the connecting piece and typically being open, is positioned such that the lines can be inserted and removed approximately in a direction perpendicular to the pivoting plane. This prevents the line from undesirably falling out during operation. By means of the proposed design, the segments are designed such that reaction forces of the lines during movement in the deflecting bend act radially outward or radially inward either on the central region or on a side part, and not in the direction of the connecting piece or of the insertion opening, which is typically situated opposite the connecting piece.

The proposed design having receiving regions provided on both sides of the central regions may also, depending on orientation, offer the advantage that the weight load of cantilevered regions acts parallel to the main plane on the central regions or flexible joint regions, and said regions thus act in the manner of a web of a beam, that is to say can achieve a high load-bearing action with a relatively small wall thickness. Here, the central regions or the flexible joint regions may have dimensions in a direction perpendicular to the pivoting plane which amount to an at least predominant fraction of the corresponding dimension of the receiving spaces, preferably at least 80%, for example 100% of said dimension of the receiving spaces.

The line guiding device according to the invention has no distinct rotary joint connections, and in particular also does not require any separate sliding or connecting band for flexibly connecting the links.

For the intended limitation of the pivot angle of the segments that are pivotable relative to one another, it is preferable if mutually averted end faces, which point in the longitudinal direction and/or extend transversely to the pivoting plane, of at least one of the first and second side parts interact as stops for the purposes of pivot angle limitation. Here, in particular, corresponding first end faces of the first side parts may limit the pivot angle at one side or in one direction of rotation into a straightened position, and/or corresponding second end faces of the second side parts may limit the pivot angle at the other side or in the other direction of rotation, for example into a maximally angled relative position when forming the deflecting bend.

It is preferable if, relative to a straightened position, for example for forming a straightened strand, at least some single-part longitudinal portions are pivotable only in one direction of rotation to form the deflecting bend. In particular, for this purpose, the first and second side parts may preferably have different lengths in the longitudinal direction, in order to achieve different abutting actions and limit the pivot angles to different degrees. The proposed design can however advantageously also be used for line guiding devices that allow backward bending (counter to the deflecting bend).

For improved retention of the lines, it is preferable if, on at least one of the side parts, a retaining region, in particular a retaining region situated opposite the connecting piece and projecting toward the central region, is provided for holding the line in the associated receiving space. Here, the retaining region may be formed by a separately manufactured retaining element that is fitted onto the segment. By contrast, the retaining region is particularly preferably manufactured as a single part with the side part, in particular as a single part with the side part, connecting piece and central region. This may preferably be achieved by virtue of a demolding aperture being provided, correspondingly to the retaining region, in the connecting piece, wherein the demolding aperture is provided opposite the retaining region and has dimensions corresponding to at least the area of the retaining region in a projection onto the pivoting plane, and the connecting piece has larger dimensions at least in the longitudinal direction than the retaining region. This allows the retaining regions to be manufactured by injection molding using simple so-called open/closed tools, because the demolding aperture allows the retaining regions to be demolded from such an injection mold.

Altogether, depending on the total length that is desired for the application, the line guiding device may be assembled from multiple guide pieces that are connected in the longitudinal direction. Here, the guide pieces may each comprise a number of segments and may each be manufactured as a single part in accordance with the aforementioned approach.

In particular, each guide piece may comprise a supporting band formed from successive central regions and joint regions connected as a single part, in particular a supporting band extending with a main plane perpendicular to the pivoting plane and/or in the longitudinal direction. Here, one of two interacting connectors may be provided at each of the two longitudinal ends of the supporting band, in order to interconnect the individual guide pieces in the longitudinal direction.

In a preferred embodiment of the connectors, at least one first connector is formed by the central region of an end segment of the guide piece, and/or a second connector is formed at a free end of a joint region of the guide piece. In a further preferred embodiment of the connectors, the interacting connectors are designed for form-fittingly and/or force-fittingly connecting the supporting bands of two successive guide pieces, preferably such that the connection can be made and/or released exclusively in a direction perpendicular to the pivoting plane.

The connectors are particularly preferably designed such that the connection can be made without the use of tools, preferably exclusively in a direction perpendicular to the pivoting plane.

The interacting connectors preferably have abutment surfaces perpendicular to the pivoting plane, which abutment surfaces lie against one another in the connected state. A stable connection in the supporting strand can thus be achieved.

Further preferred design variants provide one or more of the following features or combinations thereof:
each longitudinal portion or each guide piece comprises a number of at least three single-part segments, in particular of identical design; and/or
in each segment, the side parts are substantially parallel to the main plane and/or the connecting pieces are substantially perpendicular to the main plane of the central region; and/or
each segment has, perpendicularly to the longitudinal direction, a cross section which is substantially double-U-shaped or UU-shaped or [symbol] -shaped, and/or has a cross section having three substantially parallel limbs formed by outer side parts and the central region in between; and/or
at least one longitudinal portion or guide piece is formed with joint regions that are pre-curved in a rest position, or segments that are pre-pivoted relative to one another; this makes it possible to achieve a preload and also facilitates manufacture as a single part in the molding tool; and/or
each segment is designed to limit a movement of a line, which is received in a receiving space, in at least three directions perpendicular to the main plane, in particular in both directions perpendicular to the main plane and in at least one direction parallel to the pivoting plane, in particular vertically downward.

In one preferred embodiment, the joint regions are of plate-like design having a main plane perpendicular to the pivoting plane and having a reduced wall thickness in relation to the central regions. Here, the wall thickness is preferably several times smaller, for example at least three times smaller, than the longitudinal dimension of the joint region in the longitudinal direction, and/or several times smaller, for example at least three times smaller, than the width dimension of the joint region perpendicular to the pivoting plane.

The central regions connected as a single part by means of the joint regions, together with the joint regions, preferably act as a supporting band and/or define the neutral axis of the line guiding device.

The line guiding device may preferably be designed to be used in a lying configuration, with the neutral axis or the supporting band in particular being oriented vertically. However, with an unchanged design, the line guiding device can also be used in a conventional standing configuration with a lower strand and an upper strand.

In a particularly preferred embodiment, each longitudinal portion or each guide piece is manufactured as a single part from plastics material, in particular by injection molding. Here, the guide piece may preferably be formed from a materially uniform plastics material, in particular from a uniform plastics material in the joint regions and in the further regions such as connecting pieces and side parts.

For the purposes of fastening the ends at the connection point(s), at least some central regions preferably have a fastening opening extending in the main plane, in particular for fastening screws. The need for special end connection components can thus be avoided by virtue of the fastening function already being integrated into the guide pieces or components of the line guiding device.

The invention also relates to a single-part guide piece for a line guiding device for movably guiding at least one supply line, for example an electrical or data cable, between two connection points, at least one of which is movable relative to the other, wherein the guide piece comprises a plurality of segments, in particular at least three segments, and is manufactured as a single part, wherein the segments are interconnected in a longitudinal direction by means of a flexible connection, such that the segments are pivotable relative to one another in a pivoting plane for the purposes of forming a deflecting bend during movement of the line guiding device, and wherein the segments define at least one receiving space in which at least one supply line can be placed and held.

According to the invention, the segments each have a central region having a main plane perpendicular to the pivoting plane, having on a first side of the main plane a first receiving space which is delimited by a first connecting piece transverse to the main plane and by a first side part held on said connecting piece and by a first main surface of the central region, and having on an opposite, second side of the main plane a second receiving space which is delimited by a second connecting piece transverse to the main plane and by a second side part held on said connecting piece and by a second main surface of the central region.

Furthermore, according to the invention, the first and the second connecting piece and the first and the second side part may each be manufactured as a single part with the central region, and/or a flexible joint region may be manufactured as a single part with the central regions of in each case two longitudinally successive segments in order to provide the flexible connection between said segments.

The proposed individual component or guide piece can accordingly be manufactured relatively easily as an injection molded part from plastics material. It may have one or more refining features according to the description above.

The proposed line guiding device can be manufactured from inexpensive individual components or guide pieces and assembled with relatively little effort.

The proposed line guiding device is in particular highly suitable for relatively short traveling distances or movement lengths, typically ≤3 m.

The proposed line guiding device is suitable in particular for use in a server rack comprising a frame for the installation of holding rails for servers that can be pulled out in the manner of drawers, wherein the line guiding device serves for providing a supply to a server that can be pulled out in the manner of a drawer, for example for maintenance purposes. In principle, the invention is particularly suitable for line guidance in applications in which a particularly flat design of the device is advantageous, for example for any type of pull-out drawers or for example in server racks.

### BRIEF DESCRIPTION OF THE DRAWINGS

Further details, advantages and features of the invention will become apparent from the following description of two exemplary embodiments on the basis of the appended drawings. In the drawings:

FIG. 1: shows a first exemplary embodiment of a line guiding device formed from single-part guide pieces;

FIG. 2A-2E: show views of a guide piece manufactured as a single part as a main component of a line guiding device according to FIG. 1, in cross section (FIG. 2A, FIG. 2B: cf. section lines A-A and B-B in FIG. 2C), in a plan view or side view (FIG. 2C), in a view from below or from the rear (FIG. 2D), and in a perspective view (FIG. 2E);

FIG. 2F: shows a perspective view of two guide pieces according to FIG. 2A-2E having complementary connecting regions for the connection of the guide pieces; and

FIG. 3A-3B: show a second exemplary embodiment of a line guiding device according to the invention, in this case having guide pieces manufactured as a single part (FIG. 3A), the segments of which are also pivotable backward relative to one another (cf. FIG. 3B).

### DETAILED DESCRIPTION

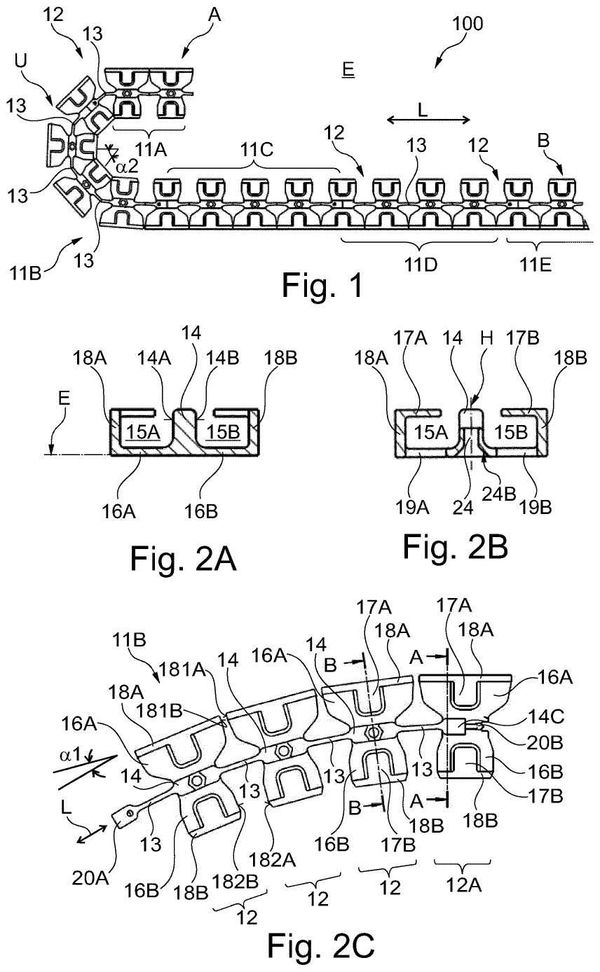

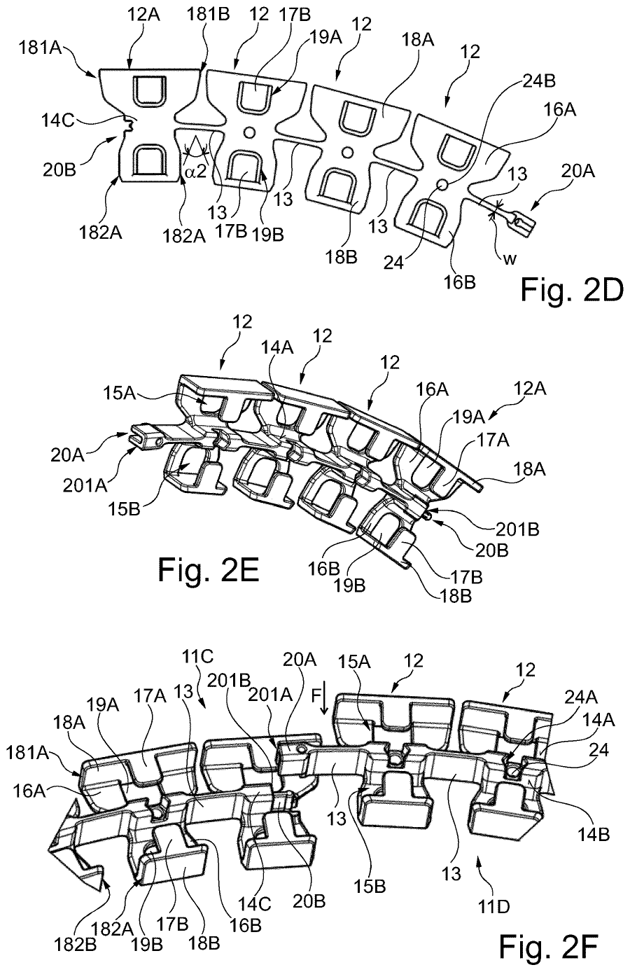

FIG. 1 shows, in a plan view or from above, a line guiding device 100 that is used in a preferably lying configuration. The line guiding device 100 serves for movably or dynamically guiding at least one supply line, for example an electrical or data cable (not shown), between two connection points A, B. At least one of the connection points A, B is movable relative to the other, for example linearly in the plane of FIG. 1. The line guiding device 100 has a plurality of successive longitudinal portions formed by individual guide pieces 11A . . . 11E that are interconnected in a longitudinal direction L. As will be described in more detail below on the basis of FIG. 2A-2E, each of the guide pieces 11A . . . 11E is manufactured as a single part and has a plurality of single-part segments 12, 12A that are successive in the longitudinal direction L.

The link-like segments 12 of a guide piece 11A . . . 11E are each flexibly interconnected in the longitudinal direction L by flexible joint regions 13, that is to say the intentionally elastically flexible joint regions 13 each form a flexible connection between the individual segments 12. The intrinsically relatively flexurally rigid segments 12 are thus pivotable relative to one another in a pivoting plane E, which in FIG. 1 corresponds to the plane of the drawing. In the preferred lying configuration, the pivoting plane E in which the longitudinal direction L lies is substantially horizontal. When the movable connection point A moves back and forth in the longitudinal direction, the line guiding device 100 forms a deflecting bend U, by which the segments 12 are deflected. Alternatively, the line guiding device 100 may also be used in a standing configuration in a substantially vertical pivoting plane E or with a vertically arranged deflecting bend U.

FIG. 2A-2E show one of the plurality of structurally identical, single-part guide pieces 11A . . . 11E, in this case for example the guide piece 11B, in the non-angled rest state. Here, the joint regions 13 are manufactured with a slight pre-curvature, such that the individual segments 12 are already slightly angled relative to one another when in an unloaded rest position. This generates a preload and facilitates the manufacture of the single-part guide pieces 11A . . . 11E in simple injection molding tools. The guide pieces 11A . . . 11E are preferably manufactured as single-part injection molded parts from a thermoplastic plastics material, optionally with reinforcement fibers.

FIG. 2A and FIG. 2B show cross sections corresponding to the section lines A-A and B-B in FIG. 2C, that is to say perpendicular to the pivoting plane E or plane of FIG. 2C.

As can be seen most clearly from FIG. 2A-2B, the segments 12 each have a central region 14 having a main plane H which is oriented in the longitudinal direction and perpendicularly to the pivot plane E and to the plane of the drawing in FIG. 2A-2B. Each segment 12 forms a first receiving space 15A on a first side of the main plane H and a second receiving space 15B on an opposite, second side of the main plane H.

The first space 15A is delimited by a first connecting piece 16A, by a first outer side part 18A provided on said connecting piece 16A, and by a first main surface 14A of the central region 14. The first connecting piece 16A extends substantially transversely to the main plane H or parallel to the pivoting plane E and holds the first side part 18A on the central region 14. The first side part 18A extends or is arranged approximately parallel to the main plane H or to the main surface 14A of the central region 14. Analogously to this, the second receiving space 15B is delimited by a first connecting piece 16B, by a second outer side part 18B provided on said connecting piece 16B, and by a second main surface 14B of the central region 14. The second connecting piece 16B also extends substantially transversely to the main plane H or parallel to the pivoting plane E and holds the second side part 18B on the central region 14. The second side part 18B extends or is arranged approximately parallel to the main plane H or to the main surface 14B of the central region 14.

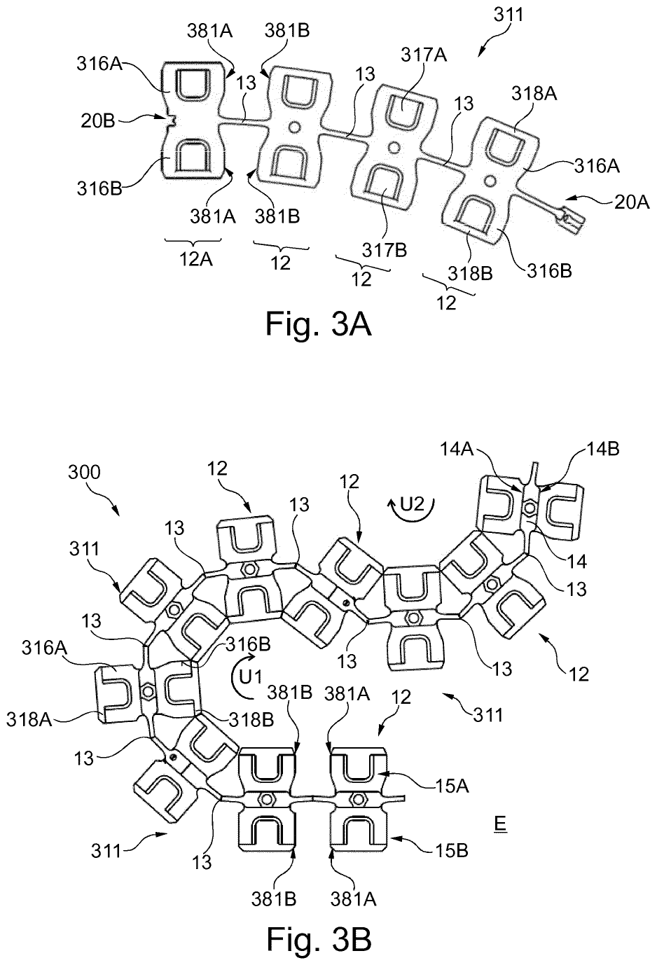

In FIG. 2A-2F, the second side parts 18B are dimensioned differently, in particular are shorter in the longitudinal direction, than the first side parts 18A (by contrast, for example, to FIG. 3A-3B). The connecting pieces 16A and 16B hold the side parts 18A and 18B respectively on the central region. At the same time, the connecting pieces 16A, 16B serve, in the associated receiving space 15A, 15B, as a rest for supporting lines downwardly, in the case of a lying configuration (as in FIG. 1), or laterally to the outside, in the case of a standing configuration, depending on the application. The side parts 18A and 18B hold the lines (not shown) in the radially outward direction or inward direction in relation to the deflecting bend U, that is to say in the lateral direction or in the vertical direction in the receiving space 15A or 15B depending on the application.

As can be seen most clearly from FIG. 2A, the first and the second connecting piece 16A, 16B and the first and the second side part 18A, 18B are each manufactured as a single part with the central region 14.

Furthermore, on each of the side parts 18A, 18B, a retaining region 17A, 17B is provided which is situated opposite the connecting piece 16A or 16B respectively and which projects inward toward the central region 14. The retaining regions 17A, 17B serve to hold the line in the associated receiving space 15A, 15B in the upward direction in relation to FIG. 2A-2B. Between the two preferably identically dimensioned retaining regions 17A, 17B and the central region 14, an access opening is provided, which remains free, for the purposes of inserting and removing lines (not shown) into and from the associated receiving space 15A or 15B. The identical basic shape of the retaining regions 17A, 17B is approximately D-shaped, with rounded portions on the end pointing toward the central region 14.

In each connecting piece 16A and 16B, a demolding aperture 19A, 19B is provided correspondingly to the oppositely situated retaining region 17A, 17B. In the example shown, the retaining regions 17A, 17B and thus the demolding apertures have an identical, for example approximately D-shaped, basic shape on both sides or at each of the receiving spaces 15A, 15B. Each demolding aperture 19A, 19B is situated opposite the associated retaining region 17A, 17B and has dimensions having at least the area of the retaining region 17A, 17B or of the projection onto the pivoting plane E. Correspondingly, the connecting piece 16A, 16B has larger dimensions at least in the longitudinal direction L, preferably also perpendicularly to the main plane H, than the retaining region 17A, 17B, as can be seen most clearly in the view from the rear in FIG. 2D. This simplifies the molding tools, because no slides are required for undercuts. Also, each retaining region 17A or 17B is preferably, together with the rest of the segment 12 or 12A, connected as a single part to, and manufactured as a single part with, the central region 14 via the side part 18A or 18B respectively and the connecting piece 16A or 16B respectively, in particular by injection molding. It would alternatively be possible for retroactively installed retaining elements or holding pieces to be provided.

FIG. 2C also shows first end faces 181A, 181B, which have an abutting action, of the first side parts 18A, and second end faces 182A, 182B, which have an abutting action, of the second side parts 18B. To limit the pivot angle al of two segments 12 relative to one another into the straightened position (cf. FIG. 1, the lower portion, for example at guide piece 11D), the mutually averted end faces 181A, 181B, which point in the longitudinal direction and extend transversely to the pivoting plane E, of the first side parts 18A interact as stops. To limit the pivot angle α2 of two segments 12 relative to one another into the fully deflected direction or to form the deflecting bend (cf. FIG. 1), the mutually averted end faces 182A, 182B, which point in the longitudinal direction and extend transversely to the pivoting plane E, of the second side parts 18B interact as stops when the segments 12 are in the maximally angled relative position. The end faces 182A, 182B are arranged so as to extend obliquely with respect to one another at a corresponding angle α2, such that the end faces 182A, 182B can lie flush against one another when they are in abutting contact.

The different effect of the stops in FIG. 1-2 will become clear from a comparison with the exemplary embodiment in FIG. 3B.

The central regions 14 and joint regions 13 form, within each guide piece 11A . . . 11E, a type of supporting band which, in particular, extends with its main plane H perpendicular to the pivoting plane E and approximately defines the longitudinal direction L. One of two interacting, correspondingly designed connectors 20A, 20B is provided on each of the two longitudinal ends of the supporting band formed by central regions 14 and joint regions 13. By means of the connectors 20A, 20B, a plurality of guide pieces 11A . . . 11E are interconnected in the longitudinal direction to form a line guiding device 100 of a desired length. If required, guide pieces 11A and 11E situated at the ends may be cut to a desired length, as indicated in FIG. 1.

As shown in more detail in FIG. 2C-2E, in each case one joint region 13 is manufactured as a single part or as one piece with each of the central regions 14. The identical joint regions 13 are intentionally elastically flexible in the pivoting plane E, such that a flexible connection of two segments 12 that are successive in the longitudinal direction L is achieved. The flexibility of the joint region 13 is achieved in particular by virtue of a wall thickness of the joint region 13 being significantly reduced in relation to the structural length in the longitudinal direction L or structural height perpendicular to the pivoting plane. Here, the wall thickness W may for example preferably lie in a range from approximately 5%-20%, in particular approximately 7.5%-15%, of the structural length and/or structural height. The flexible joint regions 13 may thus be of plate-like design, as can be seen for example in FIG. 2E, and they preferably extend substantially in the main plane H (at least in a straightened state).

By contrast, the central regions 14 have a significantly greater wall thickness, as measured between the main surfaces 14A, 14B, than the joint regions 13, as can be seen in FIG. 2A. Said wall thickness preferably amounts to at least three times the wall thickness W of the joint regions 13. The central regions 14 are thus more flexurally rigid and preferably torsionally rigid than the joint regions 13, such that, when the segments 12 are angled in the deflecting bend U (FIG. 1), only the joint regions 13 are elastically deformed by bending (NB: in FIG. 1 and FIG. 3, the actual arcuate curvatures of the joint regions 13 are not illustrated for technical reasons).

In the example shown in FIG. 2A-2E, each single-part guide piece 11A . . . 11E has a total of four segments 12, 12A, wherein all of the segments are of substantially identical dimensions and of structurally identical design, with the exception of an end segment 12A, which has a specially designed central region 14C. On the central region 14C of said end segment 12A, a connector 20B is provided, for example as a positive form or male connector for connection to a corresponding, for example female connector 20A of the next guide piece 11A . . . 11E.

FIG. 2C-2E shows the connectors at the opposite longitudinal ends in more detail. Here, the female connector 20A is provided on the free end of a joint region 13 protruding from one end, and is coupled to the male connector 20B, in this case on the central region 14° C. of the other end region. The connectors 20A, 20B are formed with complementary outer contours such that, when joined together, they produce a closed form corresponding to the outer contour of the other central regions 14 of the mutually structurally identical segments 12 of the guide piece 11A . . . 11E.

In order to connect two guide pieces 11C, 11D, the connectors 20A, 20B are joined by way of a movement in a joining direction F substantially or exactly perpendicular to the pivoting plane E, as shown in more detail in FIG. 2F. The connectors 20A, 20B interact in order to form-fittingly and force-fittingly connect the supporting bands of two successive guide pieces. The connection can preferably be made exclusively in a direction perpendicular to the pivoting plane, in particular without the use of tools, and is preferably non-destructively releasable only by using suitable tools. As can be seen in FIG. 2D-2F, the connectors 20A, 20B form respective abutment surfaces 201A, 201B which are perpendicular to the pivoting plane E and which lie firmly against one another in the connected state.

With the exception of the end segment 12A having the central region 14C and connector 20B, the three further segments 12 have, in their central region, a fastening opening 24 extending all the way through, wherein a recess 24A having a hexagonal opening, for example for hexagonal nuts or cylinder head screws, is provided at one mouth of the fastening opening 24, and a conical recess 24B for a countersunk head screw is provided at the opposite mouth of the fastening opening 24. By means of the fastening opening 24 and coaxial recess 24A or 24B, each segment 12 can be selectively fastened at the connection point A, B, wherein an excess length can be removed by severing at the joint connector 13.

A second exemplary embodiment of a line guiding device 300 consisting of a plurality of single-part guide pieces 311 will be briefly described with reference to FIG. 3A-3B, wherein only the main differences in relation to FIG. 1-2 will be briefly discussed. It is again the case that each guide piece 311 has a plurality of segments each having a central region 14 and a joint region 13, and a receiving space 15A, 15B on each side thereof. As shown in FIG. 3B, however, by contrast to FIG. 1, the guide piece 311 is deformable in two pivoting directions or in opposite curvature directions U1 and U2. In the guide piece 311, the segments have identically dimensioned first and second connecting pieces 316A, 316B and identically dimensioned first and second side parts 318A, 318B on both sides, that is to say at each receiving space 15A, 15B, which means that the end faces 381A, 381B have the same angle-limiting or abutting action on both sides of the supporting strand or of the main surface. Slightly differing angle limitation can also be implemented. The retaining regions 317A, 317B are also structurally identical. The line guiding device 300 can thus also be used for applications involving backward bending, for example in the opposite curvature directions U2. The guide piece 311 from FIG. 3A-3B can also be manufactured inexpensively from plastics material as a single-part injection molded part.

### LIST OF REFERENCE SIGNS

FIG. 1, FIG. 2A-2E
100 Line guiding device
11A . . . 11E Longitudinal portion or guide piece
12 Segments
13 Joint region
14 Central region
14A, 14B Main surface (of the central region 14)
15A First receiving space
15B Second receiving space
16A First connecting piece
16B Second connecting piece
17A First retaining region
17B Second retaining region
18A First side part
18B Second side part
181A, 181B First end faces
182A, 182B Second end faces
20A, 20B Corresponding connectors
201A, 201B Abutment surface
24 Fastening opening
24A, 24B Recesses
A, B Connection points
E Pivoting plane
F Joining direction
H Main plane
L Longitudinal direction
U Deflecting bend
W Wall thickness (joint region)
α1, α2 Pivot angles

FIG. 3A-3B
300 Line guiding device
311 Guide piece
316A First connecting piece
316B Second connecting piece
317A First retaining region
317B Second retaining region
318A First side part
318B Second side part
381A, 381B End faces
U1, U2 Curvature direction

What is claimed is:

1-17. (canceled)

18. A line guiding device for movably guiding at least one supply line between two connection points, at least one of which is movable relative to the other, comprising:
at least one longitudinal portion of the line guiding device comprises a plurality of segments and is manufactured in one piece;
wherein the plurality of segments are connected to each other in a longitudinal direction by a flexible connection, such that the plurality of segments are pivotable relative to one another in a pivoting plane for the purposes of forming a deflecting bend during movement of the line guiding device;
wherein the plurality of segments define at least one receiving space in which at least one supply line is placeable and held;
wherein the plurality of segments each have a central region having a main plane perpendicular to the pivoting plane, having on a first side of the main plane a first receiving space which is delimited by a first connecting piece transverse to the main plane and by a first side part held on the first connecting piece and by a first main surface of the central region, and having on an opposite, second side of the main plane a second receiving space which is delimited by a second connecting piece transverse to the main plane and by a second side part held on the second connecting piece and by a second main surface of the central region;
wherein the first and the second connecting piece and the first and the second side part are each manufactured in one piece with the central region;
wherein, opposite the first and the second connecting piece, there is in each case one insertion opening for the insertion and removal of supply lines;
wherein a flexible joint region is manufactured in one piece with the central regions of in each case two longitudinally successive segments in order to provide the flexible connection between the segments; and
wherein, on at least one of the side parts, a retaining region is provided for holding the line in the respected receiving space.

19. The line guiding device as claimed in claim 18, wherein mutually averted end faces, which face in the longitudinal direction and/or extend transversely to the pivoting plane, of at least one of the first and second side parts interact as stops for limiting a pivot angle of two segments relative to one another.

20. The line guiding device as claimed in claim 19, wherein corresponding first end faces of the first side parts limit the pivot angle in a straightened position, and/or corresponding second end faces of the second side parts limit the pivot angle in a maximally angled relative position when forming the deflecting bend, wherein, preferably, the first and second side parts have different lengths in the longitudinal direction.

21. The line guiding device as claimed in claim 18, wherein the retaining region is arranged opposite the connecting piece and so as to project toward the central region.

22. The line guiding device as claimed in claim 21, wherein the retaining region is manufactured as a single part with the side part, in particular as a single part with the side part, connecting piece and central region, and a demolding aperture is provided, correspondingly to the retaining region, in the connecting piece.

23. The line guiding device as claimed in claim 18, wherein the line guiding device is a multi-part line guiding device which is assembled from a plurality of guide pieces that are connected in the longitudinal direction, wherein the guide pieces each comprise a number of segments and are each manufactured in one piece, and each guide piece comprises a supporting band formed from connected in one piece successive central regions and joint regions, in particular a supporting band extending with a main plane perpendicular to the pivoting plane and/or extending in the longitudinal direction, wherein one of two interacting connectors is provided at each of the two longitudinal ends of the supporting band.

24. The line guiding device as claimed in claim 23, wherein at least one connector is formed by the central region of an end segment of the guide piece, and/or one connector is formed at a free end of a joint region of the guide piece.

25. The line guiding device as claimed in 23, wherein the interacting connectors are configured for form-fittingly and/or force-fittingly connecting the supporting bands of two successive guide pieces, preferably such that the connection is establishable and/or releasable exclusively in a direction perpendicular to the pivoting plane, and in particular is establishable without the use of tools.

26. The line guiding device as claimed in any one of claims 23, wherein the interacting connectors have abutment surfaces which are perpendicular to the pivoting plane and which lie against one another in the connected state.

27. The line guiding device as claimed in claim 18, wherein:
each longitudinal portion or each guide piece comprises a number of at least three one-piece segments, in particular of identical design; and/or
in each segment, the side parts are substantially parallel to the main plane and/or the connecting pieces are substantially perpendicular to the main plane of the central region; and/or
each segment has a cross section perpendicularly to the longitudinal direction which is substantially double-U-shaped or UU-shaped or -shaped, having three substantially parallel limbs formed by outer side parts and the central region in between; and/or
at least one longitudinal portion or guide piece is formed with joint regions that are pre-curved in a rest position, or segments that are pre-pivoted relative to one another, for the purposes of achieving a preload; and/or
each segment is configured to limit a movement of a line, which is received in a receiving space, in at least three directions perpendicular to the main plane.

28. The line guiding device as claimed in claim 18, wherein the joint regions are of plate-like design having a main plane perpendicular to the pivoting plane and having a reduced wall thickness in relation to the central regions, wherein the wall thickness is preferably several times smaller than the longitudinal dimension of the joint region in the longitudinal direction and several times smaller than the width dimension of the joint region perpendicular to the pivoting plane.

29. The line guiding device as claimed in claim 18, wherein the joint regions and central regions connected thereto in one-piece act as a supporting band and define the neutral axis of the line guiding device, wherein the line guiding device is preferably configured to be used in a lying configuration with a vertically oriented neutral axis.

30. The line guiding device as claimed in claim 18, wherein each longitudinal portion or each guide piece is manufactured in one piece from plastics material, in particular by injection molding, preferably from a materially uniform plastics material.

31. The line guiding device as claimed in claim 18, wherein at least some central regions have a fastening opening extending in the main plane.

32. The line guiding device as claimed in claim 18, wherein the insertion opening is configured for the insertion and removal of supply lines in a direction transverse to the pivoting plane.

33. The line guiding device as claimed in claim 18, wherein the line guiding device is disposed with a server rack for at least one server, wherein the line guiding device serves to provide a supply to the at least one server.

34. A one-piece guide piece for a line guiding device for movably guiding at least one supply line between two connection points, at least one of which is movable relative to the other, comprising:
wherein the guide piece comprises a plurality of segments and is manufactured in one piece;
wherein the plurality of segments are connected to each other in a longitudinal direction by a flexible connection, such that the plurality of segments are pivotable relative to one another in a pivoting plane for the purposes of forming a deflecting bend during movement of the line guiding device;
wherein the plurality of segments define at least one receiving space in which at least one supply line can be placed and held;
wherein the plurality of segments each have a central region having a main plane perpendicular to the pivoting plane, having on a first side of the main plane a first receiving space which is delimited by a first connecting piece transverse to the main plane and by a first side part held on the first connecting piece and by a first main surface of the central region, and having on an opposite, second side of the main plane a second receiving space which is delimited by a second connecting piece transverse to the main plane and by a second side part held on the second connecting piece and by a second main surface of the central region;
wherein the first and the second connecting piece and the first and the second side part are each manufactured in one piece with the central region;
wherein, opposite the first and the second connecting piece, there is in each case one insertion opening for the insertion and removal of supply lines;
wherein a flexible joint region is manufactured in one piece with the central regions of in each case two longitudinally successive segments in order to provide the flexible connection between the segments; and
wherein, on at least one of the side parts, a retaining region is provided for holding the line in the associated receiving space.

35. The one-piece guide piece as claimed in 34, wherein the insertion opening is configured for the insertion and removal of supply lines in a direction transverse to the pivoting plane.
